(19) United States
(12) Patent Application Publication
(10) Pub. No.: US 2024/0268284 A1
(43) Pub. Date: Aug. 15, 2024

(54) TERRAIN STRUCTURE AND METHOD OF GROWING PLANTS USING THE SAME

(71) Applicants: Gi Won LEE, Suwon-si (KR); Kang Myung LEE, Suwon-si (KR)

(72) Inventors: Gi Won LEE, Suwon-si (KR); Kang Myung LEE, Suwon-si (KR)

(73) Assignees: Gi Won LEE, Suwon-si, KG (KR); Kang Myung LEE, Suwon-si, KG (KR)

(21) Appl. No.: 18/569,349

(22) PCT Filed: Apr. 27, 2022
(86) PCT No.: PCT/KR2022/006051

§ 371 Date: Dec. 12, 2023

(30) Foreign Application Priority Data
Jun. 22, 2021 (KR) 10-2021-0080705

(51) Int. Cl. A01G 24/40; A01G 24/35; A01G 25/16

(52) U.S. Cl. CPC A01G 24/40; A01G 24/35; A01G 25/16

(57) ABSTRACT

A terrain structure includes a ground surface layer; a dry layer, a water-containing layer, and a root-growth part. The dry layer is formed under the ground surface layer and has a relatively low water-permeability for allowing water to permeate thereinto from the ground surface layer and/or a relatively low water-containing capacity for containing the water. The water-containing layer is formed under the dry layer, and has a relatively high water-permeability and/or water-containing capacity. The root-growth part has a structure in which a water-permeable material and/or a hygroscopic material is filled between the ground surface layer and the water-containing layer to allow the water supplied to the ground surface layer to permeate into the water-containing layer through the root-growth part, so that when a plant having roots is planted on the ground surface layer, the roots of the plant can grow from the ground surface layer to the water-containing moisture layer.

### TECHNICAL FIELD

The present invention relates to a terrain structure and a method of growing plants using the terrain structure. More particularly, the present invention relates to a terrain structure formed to enable the cultivation of plants in a dry layer with a relatively low permeability to permeate water from the ground surface layer and/or a relatively low water-holding capacity, and to a method for cultivating plants with the terrain structure.

### BACKGROUND ART

When a dry layer with a relatively low permeability and/or water-holding capacity to water is formed below a ground surface layer, the roots of plants may not be able to grow up to a water-containing layer with a relatively high permeability and/or a relatively high water-holding capacity formed below the dry layer, resulting in a situation where the plant dies.

Therefore, when cultivating plants with roots in a terrain where a dry layer is formed, it is necessary to continuously supply water to prevent the plants from dying due to water shortages.

Conventionally, when cultivating a plant having roots in a terrain where a dry layer of soil is formed, there may be a disadvantage that a very large amount of water must be continuously supplied. In particular, despite the continuous supply of a large amount of water, the roots of the plant do not grow deeply in the direction of the water-containing layer under the dry layer, but grow shallowly along the side below the ground surface layer, which may even lead to a situation where the plant is uprooted when an external impact such as a strong wind is applied.

### DISCLOSURE OF THE INVENTION

### Problems to be Solved

The present invention is directed to solving the problems described above. It is an object of the present invention to provide a terrain structure that allows plant roots to grow downwards into the water-containing layer below the dry layer.

It is another object of the present invention to provide a method of growing plants that facilitates the cultivation of plants having roots in a terrain structure having a dry layer of soil.

The problems to be solved by the present invention are not limited to the problems described above, and may be expanded in various ways without departing from the spirit and scope of the present invention.

### Means to Solve the Problems

A terrain structure according to exemplary embodiments of the present invention to achieve the object includes a ground surface layer; a dry layer, formed under the ground surface layer, having a relatively low water-permeability for allowing water to permeate thereinto from the ground surface layer and/or a relatively low water-containing capacity for containing the water; a water-containing layer, formed under the dry layer, having a relatively high water-permeability and/or water-containing capacity; and a root-growth part having a structure in which a water-permeable material and/or a hygroscopic material is filled between the ground surface layer and the water-containing layer to allow the water supplied to the ground surface layer to permeate into the water-containing layer through the root-growth part, so that when a plant having roots is planted on the ground surface layer, the roots of the plant can grow from the ground surface layer to the water-containing moisture layer.

In exemplary embodiments, the root-growth part may be configured to provide a through-hole extending between the ground surface layer and the water-containing layer; and the water-permeable material and/or hygroscopic material filling-up the through-hole.

In exemplary embodiments, the root-growth part may be configured such that a water-permeable structural membrane made of the water-permeable material is formed to surround sidewalls of the through-hole, and the through-hole surrounded by the water-permeable structural membrane is filled with the water-permeable material and/or hygroscopic material.

In exemplary embodiments, the root-growth part may be configured to include the water-permeable material and/or hygroscopic material, and an insertion structure having a structure adapted to be inserted into the through-hole.

In exemplary embodiments, the terrain structure may further include a water supply unit that is provided above the ground surface layer for supplying the water to the ground surface layer on which the plant is planted.

A method of growing a plant according to exemplary embodiments for achieving the another object of the present invention includes forming a terrain structure comprising: a ground surface layer; a dry layer, formed under the ground surface layer, having a relatively low water-permeability for allowing water to permeate thereinto from the ground surface layer and/or a relatively low water-containing capacity for containing the water; a water-containing layer, formed under the dry layer, having a relatively high water-permeability and/or water-containing capacity; and a root-growth part having a structure in which a water-permeable material and/or a hygroscopic material is filled between the ground surface layer and the water-containing layer to allow the water supplied to the ground surface layer to permeate into the water-containing layer through the root-growth part; planting the plant having roots on the ground surface layer under which the root-growth portion is formed; and supplying water to the ground surface layer on which the plant is planted so that the water can permeate from the ground surface layer through the root-growth part to the water-containing layer, thereby allowing the roots of the plant to grow from the ground surface layer through the root-growth part to the water-containing layer.

In exemplary embodiments, the ‘supplying water to the ground surface layer on which the plant is planted’ may be performed by a water supply unit that is provided above the ground surface layer.

In exemplary embodiments, the supplying water may be stopped when the roots of the plant have grown downwards to the water-containing layer.

### Effects of the Invention

The terrain structure and the method of growing a plant according to exemplary embodiments of the present invention may be able to grow the roots of plant down to the water-containing layer below the dry layer in a relatively short amount of time and with a relatively small water supply.

Accordingly, the terrain structure and the method of growing a plant according to exemplary embodiments of the present invention can provide economic benefits, such as shortening the cultivation period and significantly reducing water usage when growing rooted plants.

In addition, the terrain structure and the method of growing a plant according to exemplary embodiments of the present invention can be less disturbed by the external environment because it is possible to grow roots of the plant deeply into the water-containing layer.

### BRIEF DESCRIPTION OF THE DRAWINGS

FIG. 1 is a schematic drawing to illustrate a terrain structure according to an exemplary embodiment of the present invention.

FIGS. 2 and 3 are schematic drawings illustrating a root-growth part in the terrain structure according to an exemplary embodiment of the present invention.

### DETAILED DESCRIPTION OF THE EMBODIMENTS

### Best Mode for Carrying out the Invention

The terminologies expressed in this application are used to describe specific embodiments only and are not intended to limit the invention. The singular expression includes the plural unless the context clearly indicates otherwise. In this application, the terms ‘including’, ‘comprising’ or ‘having’ are intended to designate the presence of the features, numbers, steps, actions, components, parts, or combinations thereof set forth, and are not intended to preclude the possibility of the presence or addition of one or more other features, numbers, steps, actions, components, parts, or combinations thereof.

Preferred embodiments of the present invention will now be described in more detail with reference to the accompanying drawings. Identical components in the drawings are designated by the same reference numerals and duplicate descriptions of the same component are omitted.

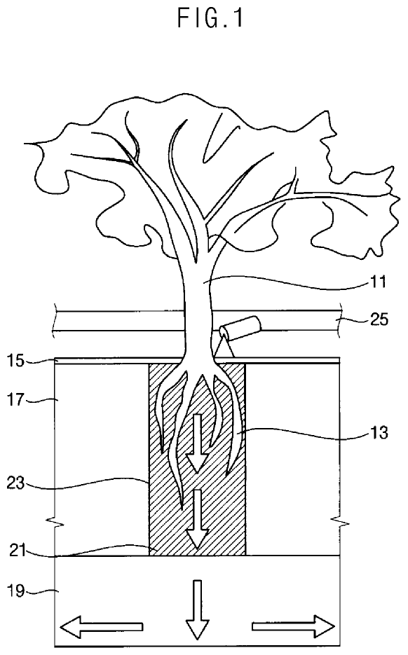

FIG. 1 is a schematic drawing to illustrate a terrain structure according to an exemplary embodiment of the present invention.

Referring to FIG. 1, the terrain structure according to the exemplary embodiment of the present invention may include a ground surface layer 15, a dry layer 17, and a water-containing layer 19.

The dry layer 17 may be formed below the ground surface layer 15 and may be a terrain layer that has a relatively low permeability, which is a property that allows water to infiltrate, and/or a relatively low water-containing property, which is a property capable of containing water. In an exemplary embodiment of the present invention, the dry layer 17 may be terrain that contains very little water.

The water-containing layer 19 may be formed below the dry layer 17 and may be a terrain element with the relatively high permeability and ability of water-containing. In an exemplary embodiment, the water-containing layer 19 may be a terrain element that contains some amount of water.

As such, in the terrain structure according to the exemplary embodiment of the present invention, the dry layer 17 that is largely impermeable to water may be formed up to a certain depth below the ground surface layer 15, and the water-containing layer 19 that contains water to some extent may be formed below the dry layer 17.

In addition, the terrain structure according to the exemplary embodiment of the present invention may further include a root-growth part 21. When a plant 11 having roots is planted 13 on the ground surface layer 15, the root-growth part 21 can allow and assist the roots 13 of the plant 11 to grow downwards from the ground surface layer 15 to the water-containing layer 19.

The root-growth part 21 may have a structure that allows water supplied from the ground surface layer 15 to permeate into the water-containing layer 19. The root-growth part 21 may be formed to have a structure filled with a water-permeable material and/or a water-absorbing (hygroscopic) material that allows water to infiltrate into itself between the ground surface layer 15 and the water-containing layer 19.

In an exemplary embodiment of the present invention, the root-growth part 21 of the terrain structure may have a structure in which a through-hole 23 is formed to penetrate the dry layer 17 between the ground surface layer 15 and the water-containing layer 19 and filled with a water-permeable material and/or a hygroscopic material.

Thus, according to the exemplary embodiment of the present invention, when a plant 11 having roots 13 is planted on the ground surface layer 15 where the root-growth part 21 is formed and water is supplied thereto, the water can permeate through the root-growth part 21 to the water-containing layer 19, and thus the roots 13 of the plant 11 will be able to grow downwards through the root-growth part 21 into which the water seeps.

In an exemplary embodiment, the root-growth part 21 may be configured to have a structure that allows water supplied from the ground surface layer 15 to get into the water-containing layer 19 downwards. For this, the root-growth part 21 may have a configuration in which a cavity is provided vertically between the ground surface layer 15 and the water-containing layer 19 and the water permeable material and/or hygroscopic (moisture-absorbing) material into which water can permeate may fill the cavity. The cavity may be formed as the though-hole 23. The through-hole 23 may be formed to penetrate the dry layer 17 so as to be surrounded by the dryer 17 between the ground surface layer 15 and the water-containing layer 19. The though-hole 23 may be filled in the vertical direction with the water-permeable material and/or the hygroscopic material which can well contain the water and transfer the water to the water-containing layer 19.

Alternatively, the root-growth part 21 may be formed to have an oblique orientation rather than the vertical orientation described above.

In an exemplary embodiment, examples of the permeable material that can be used for the root-growth part 21 may include inorganic materials such as sand, gravel, permeable soil, and the like, and organic materials such as compost, crushed plant stems, sawdust, and the like. Examples of the hygroscopic (moisture-absorbing) material may include fibers, paper, hygroscopic resins, and the like.

Furthermore, the water-permeable material and/or the hygroscopic material that can be applied as the root-growth part 21 may have a structure consisting of fine particles, for example, natural or artificial materials such as silt, diatomite, ceramics, zeolite, perlite, expanded vermiculite, crushed plant stems, and the like, having a size of about 0.1 mm or less.

The through-hole 23 for forming the root-growth part 21 may have any shape, such as, but not limited to, a circular through-hole, a tetragonal through-hole, an oval through-hole, or the like, when it penetrates from the ground surface layer 15 to the water-containing layer 19, especially when it has a vertical through-hole structure.

As such, the terrain structure according to the exemplary embodiment of the present invention may be formed with the through-hole 23 which penetrates from the ground surface layer 15 to the water-containing layer 19, and is filled with the water-permeable material and/or the hygroscopic material to form the root-growth part 21, thereby allowing the roots 13 of the plant 11 to grow from the ground surface layer 15 to the water-containing layer 19, especially downwards, even if the dry layer 17 is formed to be extended between the ground surface layer 15 and the water-containing layer 19.

And the size of the through-hole 23 in the root-growth part 21 may vary depending on the kinds of plants to be planted.

Hereinafter, the root-growth part in the terrain structure according to exemplary embodiments of the present invention will be described in more detail.

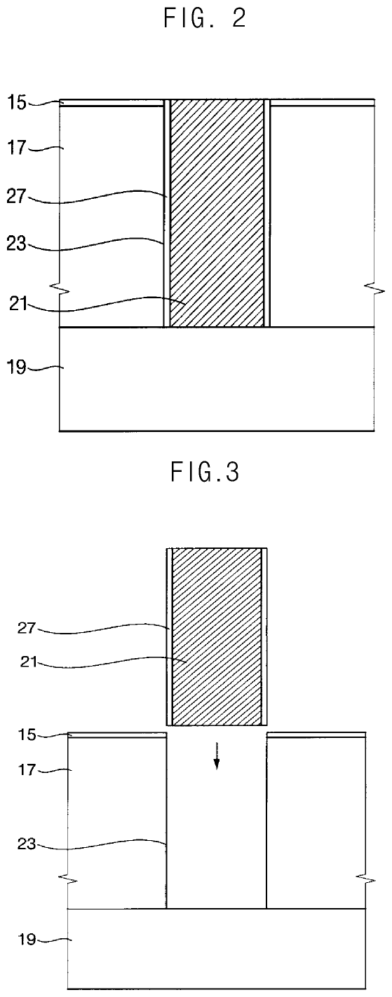

FIGS. 2 and 3 are schematic drawings to illustrate the root-growth part of the terrain structure according to exemplary embodiments of the present invention.

Referring first to FIG. 2, since a situation may arise in which the water-permeable material and/or hygroscopic material filled in the through-hole 23 to form the root-growth part 21 is lost through the side walls of the through-hole 23, the root-growth part 21 in the terrain structure according to exemplary embodiments of the present invention may be formed by separately providing a water-permeable structural membrane 27 made of water-permeable material to surround the side walls of the through-hole 23.

The mentioned water-permeable structural membrane 27 may have a net structure, mainly such as fibers made of water-permeable material.

In this way, the root-growth part 21 of the terrain structure according to exemplary embodiments of the present invention may be formed by arranging the water-permeable structural membrane 27 to surround the side walls of the through-hole 23 and then filling the through-hole 23 with the water-permeable material and/or the moisture-absorbing material, thereby minimizing the amount that the water-permeable material and/or the moisture-absorbing material filled in the through-hole 23 is lost through the side walls of the through-hole 23.

In another exemplary embodiment of the present invention, referring to FIG. 3, the root-growth part 21 of the terrain structure may be formed by inserting an insertion structure into the through-hole 23, rather than by directly filling the through-hole 23 formed in the dryer layer 17 with a permeable and/or moisture-absorbing material.

In other words, the insertion structure may be made of the permeable material and/or moisture-absorbing material in a structure or shape adapted to be inserted into the through-hole 23. The root-growth part 21 in the terrain structure according to exemplary embodiment may be formed by inserting the insertion structure into the through-hole 23.

The aforementioned insertion structure may also be formed by filling the water-permeable material and/or the hygroscopic material into the water-permeable structural membrane 27, which may have a net structure.

As such, in the terrain structure according to exemplary embodiments of the present invention, the root-growth part 21 may be obtained by arranging the water-permeable structural membrane 27 to be sized to be inserted into the through-hole 23 and then inserting the insertion structure, which is formed by filling the water-permeable structural membrane 27 with the water permeable and/or hygroscopic material, into the through-hole 23 vertically elongated.

Here, when the root-growth part 21 is formed to have a structure suitable for inserting the insertion structure into the through-hole 23, it may be more desirable for the through-hole 23 to be formed vertically for easy insertion of the insertion structure.

Referring again to FIG. 1, the terrain structure according to exemplary embodiments of the present invention will need to be watered after planting the plant 11 having roots 13.

In other words, in the exemplary embodiments of the present invention, it may be possible to supply water to the ground surface layer 15 on which the plant 11 is planted by providing a means capable of supplying water, rather than supplying water such as rainwater that may be generated by rainfall or the like and remain on the ground surface layer 15.

Thus, the terrain structure according to exemplary embodiments of the present invention may further include a water supply unit 25 that is capable of supplying water to the ground surface layer 15, such as an irrigation system or the like. Water may be supplied to the ground surface layer 15 on which the plants 11 are planted by means of the water supply unit 25.

According to exemplary embodiments of the present invention, a user may plant the plant 11 having roots 13 on the ground surface layer 15 under which the root-growth part 21 is provided, and then control the water supply unit 25 to supply water to the ground surface layer 15 where the plant 11 is planted. By this, the roots 13 of the plant 11 may be able to grow downwards from the ground surface layer 15 through the root-growth part 21 to the water-containing layer 19.

Thus, it may be possible for the terrain structure according to exemplary embodiments of the present invention to grow the roots 13 of the plant 11 to the water-containing layer 19 below the dry layer 17 despite supplying relatively little water for a relatively short period of time. Furthermore, since the roots 13 can be grown deeply into the water-containing layer 19, it may be possible to prevent the plant 11 from being pulled up even if an external impact such as a strong wind is applied.

Meanwhile, in a method of growing plants with the terrain structure according to exemplary embodiments of the present invention, after forming the root-growth part 21 illustrated in FIG. 1, FIG. 2, or FIG. 3, the plant 11 having roots 13 may be planted on the ground surface layer 15 over the root-growth part 21. Then, water may be supplied to the ground surface layer 15 on which the plant 11 is planted so that water can permeate downwards from the ground surface layer 15 through the root-growth part 21 to the water-containing layer 19. As a result, the roots 13 of the plant 11 can grow from the ground surface layer 15 through the root-growth part 21 to the water-containing layer 19.

In an exemplary embodiment, water may be supplied to the ground surface layer 15 on which the plant 11 is planted by means of the water supply unit 25 provided above the ground surface layer 15. In particular, in the method of growing plants according to exemplary embodiments of the present invention, the supply of water may be stopped once the roots 13 of the plant 11 have grown to the water-containing layer 19.

According to the method of growing plants according to exemplary embodiments of the present invention, it may be possible to stop the supply of water when the roots 13 of the plant 11 grow to the water-containing layer 19 because the water in the water-containing layer 19 is sufficient to grow the plant 11.

Therefore, the amount of water supply required for growing plants using the terrain structure and method of growing plants according to the exemplary embodiments of the present invention may be relatively small.

### INDUSTRIAL APPLICABILITY

The terrain structure and method of growing plants according to exemplary embodiments of the present invention may be more applicable to arid soil that includes dry layers that make it difficult for plant roots to grow downwards below the ground surface.

Although the above embodiments have been illustrated by way of limited drawings, it will be understood by those skilled in the art that various modifications and changes may be made to the invention without departing from the spirit and scope of the invention as set forth in the following patent claims. For example, suitable results may be achieved even if the described techniques are performed in a different order than the described methods, and/or the components of the described, structures, devices, etc. are combined or assembled in a different form than the described methods, or substituted or replaced by other components or equivalents. Therefore, other implementations, other embodiments, and equivalents of the claims are also within the scope of the following patent claims.

1. A terrain structure, comprising:
a ground surface layer;
a dry layer, formed under the ground surface layer, having a relatively low water-permeability for allowing water to permeate thereinto from the ground surface layer and/or a relatively low water-containing capacity for containing the water;
a water-containing layer, formed under the dry layer, having a relatively high water-permeability and/or water-containing capacity; and
a root-growth part having a structure in which a water-permeable material and/or a hygroscopic material is filled between the ground surface layer and the water-containing layer to allow the water supplied to the ground surface layer to permeate into the water-containing layer through the root-growth part, so that when a plant having roots is planted on the ground surface layer, the roots of the plant can grow from the ground surface layer to the water-containing moisture layer.

2. The terrain structure according to claim 1, wherein the root-growth part is configured to provide a through-hole extending between the ground surface layer and the water-containing layer; and the water-permeable material and/or hygroscopic material filling-up the through-hole.

3. The terrain structure according to claim 2, wherein the root-growth part is configured such that a water-permeable structural membrane made of the water-permeable material is formed to surround sidewalls of the through-hole, and the through-hole surrounded by the water-permeable structural membrane is filled with the water-permeable material and/or hygroscopic material.

4. The terrain structure according to claim 2, wherein the root-growth part comprises an insertion structure made of the water-permeable material and/or hygroscopic material and having a structure adapted to be inserted into the through-hole.

5. The terrain structure according to claim 1, further comprising a water supply unit that is provided above the ground surface layer for supplying the water to the ground surface layer on which the plant is planted.

6. A method of growing a plant having roots, comprising:
forming a terrain structure comprising: a ground surface layer; a dry layer, formed under the ground surface layer, having a relatively low water-permeability for allowing water to permeate thereinto from the ground surface layer and/or a relatively low water-containing capacity for containing the water; a water-containing layer, formed under the dry layer, having a relatively high water-permeability and/or water-containing capacity; and a root-growth part having a structure in which a water-permeable material and/or a hygroscopic material is filled between the ground surface layer and the water-containing layer to allow the water supplied to the ground surface layer to permeate into the water-containing layer through the root-growth part;
planting the plant having roots on the ground surface layer under which the root-growth portion is formed; and
supplying water to the ground surface layer on which the plant is planted so that the water can permeate from the ground surface layer through the root-growth part to the water-containing layer, thereby allowing the roots of the plant to grow from the ground surface layer through the root-growth part to the water-containing layer.

7. The method of growing a plant having roots according to claim 6, wherein the ‘supplying water to the ground surface layer on which the plant is planted’ is performed by a water supply unit that is provided above the ground surface layer.

8. The method of growing a plant having roots according to claim 6, wherein the supplying water is stopped when the roots of the plant have grown downwards to the water-containing layer.
